(19) United States
(12) Patent Application Publication
(10) Pub. No.: US 2019/0243436 A1
(43) Pub. Date: Aug. 8, 2019

(54) Low Voltage Reactive Power Compensation Assembly

(71) Applicant: SUHDER IND CO., LTD., Miaoli County (TW)

(72) Inventors: Der-Guey BU, Miaoli County (TW); Jia-Qing LIU, Miaoli County (TW)

(21) Appl. No.: 15/891,354

(22) Filed: Feb. 7, 2018

(51) Int. Cl. G06F 1/32; H01F 27/30; H01F 27/24

(52) U.S. Cl. CPC G06F 1/32; H01F 27/24; H01F 27/306

(57) ABSTRACT

The present invention discloses a low voltage reactive power compensation assembly includes a power saving device which comprises an iron core having an upper iron core and a lower iron core. There are pillars extended from the upper iron core and lower iron core. A sleeve having a central hollow bore is sleeved on the magnetic cores of the upper iron core and lower iron core, the sleeve comprises an upper flange and a lower flange to touch with the top portion of the upper iron core and the lower portion of the lower iron core.

### BACKGROUND OF THE INVENTION

### Field of the Invention

The present invention relates to a low voltage reactive power compensation assembly.

### Brief Description of the Prior Art

It is noted that a traditional power transmission and/or distribution system usually comprises many electric appliances assembled with a lot of electronic components. These electric devices are mainly formed as a load to the power distribution system and easily being damaged by the high frequency ripple of the power system. The power efficiency of the power distribution system is decreased due to the same reason.

Therefore, a conventional inductive electric power distribution system will usually include a power transformer made from a series of silicon metal plates to improve the disadvantage mentioned as above.

Referring to FIG. 1 which shows a schematic electric circuit diagram of a low voltage reactive power compensation assembly. The assembly comprises a three-phase four lines alternative power supply 200, a power factor improving capacitor 210, a voltage measuring sequence controller 220 to measure the feedback load voltage from the various load and an inductive power saving device 230 along with each power line.

The power saving device 230 is generally in a form of a transformer. As shown in FIG. 2 which is an exploded perspective view of the power saving device. The device 230 comprises an upper iron core 1 and a lower iron core 2. The upper iron core 1 has a central pore 3 which is corresponding to a central pore 4 of the lower iron core 2. A coil 5 is installed around the assembled central pores 3 and 4. The upper iron core 1 and lower iron core 2 each further comprises a pair of pillars 6 and 7 respectively. Each of the upper iron core 1 and lower iron core 2 is in a shape of letter E. With this power saving device 230 in the low voltage reactive power compensation assembly, it is found that the flux density will be improved to save power loss. However, this conventional power saving device 230 still does not have a high saturation flux density but with high hysteresis loss.

### SUMMARY OF THE INVENTION

It is therefore the principle object of the present invention is to provide a low voltage reactive power compensation assembly having an improved power saving device to increase the power efficiency of a power distribution system.

Another object of the present invention is to provide a low voltage reactive power compensation assembly having an improved power saving device which maintains high flux density and without eddy current and hysteresis loss.

The most important feature of the present invention is to provide a low voltage reactive power compensation assembly having an improved power saving device which comprises a magnetic iron core having an upper iron core and a lower iron core, each comprises a top portion with a plurality of pillars extended therefrom and a lower portion with a plurality of pillars extended therefrom and matching with the pillars of the top portion.

Another important feature of the low voltage reactive power compensation assembly is the upper iron core having a first magnetic core extending from the top portion, the lower iron core having a second magnetic core extending from the lower portion and coaxially in contact with the first magnetic core

Another important feature of the low voltage reactive power compensation assembly of the present invention is the upper portion of upper iron core having a pair of first slots in a half moon shape, the lower portion of the lower iron core having a pair of second slots conforming with the first slot, upper portion and lower portion further having a plurality of nodes formed thereon to be protruded into the first and second slots.

In summary, a low voltage reactive power compensation assembly includes a power saving device comprises a magnetic iron core having an upper iron core and a lower iron core, each comprises a top portion with a plurality of first pillars extended therefrom and a lower portion with a plurality of second pillars extended therefrom and matching with the first pillars of the top portion, the upper iron core having a first magnetic core extended from the top portion, lower iron core having a second magnetic core extend from the lower portion of lower iron core; a sleeve having a central hollow bore to be sleeved on said first and second magnetic cores of said upper iron core and lower iron core, said sleeve comprising an upper flange and a lower flange to touch with said top portion of said upper iron core and said lower portion of said lower iron core. said upper portion of said upper iron core having a pair of first slots in a half moon shape, said lower portion of said lower iron core having a pair of second slots conforming with said first slot, said upper portion and lower portion further having a plurality of nodes formed thereon to be protruded into said first and second slots.

### BRIEF DESCRIPTION OF THE DRAWINGS

Those and other advantages, objectives and features of the high torque ratchet wrench, in accordance with the present invention, will become more apparent from the below detailed description of the preferred embodiments with reference the accompanying drawings, wherein:

FIG. 1 is a schematic electric circuit diagram of a low voltage reactive power compensation assembly;

FIG. 2 is an exploded perspective view of a conventional power saving device used in a low voltage reactive power compensation assembly;

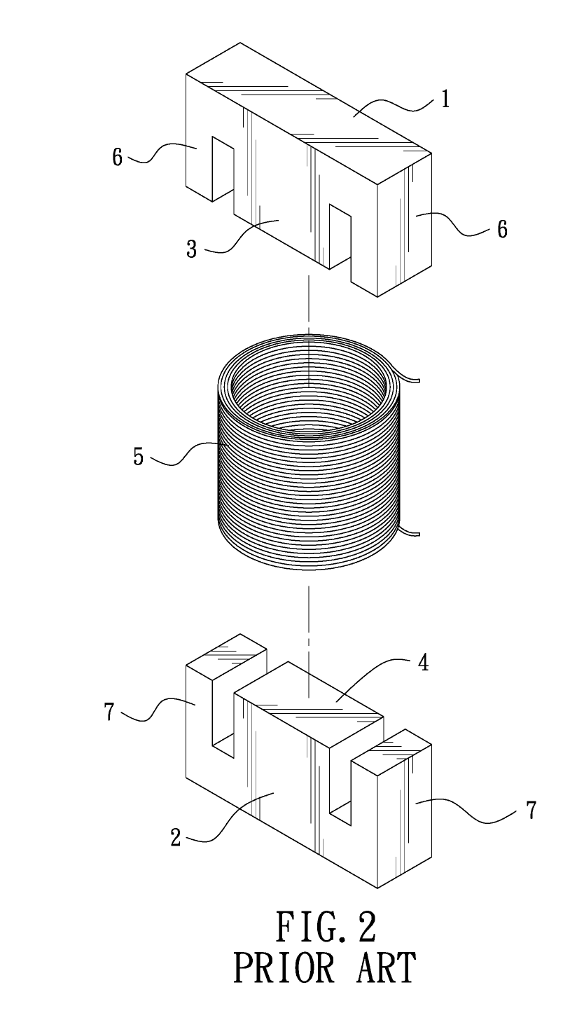

FIG. 3 a perspective view of a power saving device used in a low voltage reactive power compensation assembly according to the present invention;

FIG. 4 is an exploded perspective view of a power saving device used in a low voltage reactive power compensation assembly according to the present invention;

FIG. 5 is a sectional view of a power saving device used in a low voltage reactive power compensation assembly according to the present invention; and

FIG. 6 is a partially sectioned view of a power saving device used in a low voltage reactive power compensation assembly according to the present invention.

### DETAILED DESCRIPTION OF THE PREFERRED EMBODIMENT

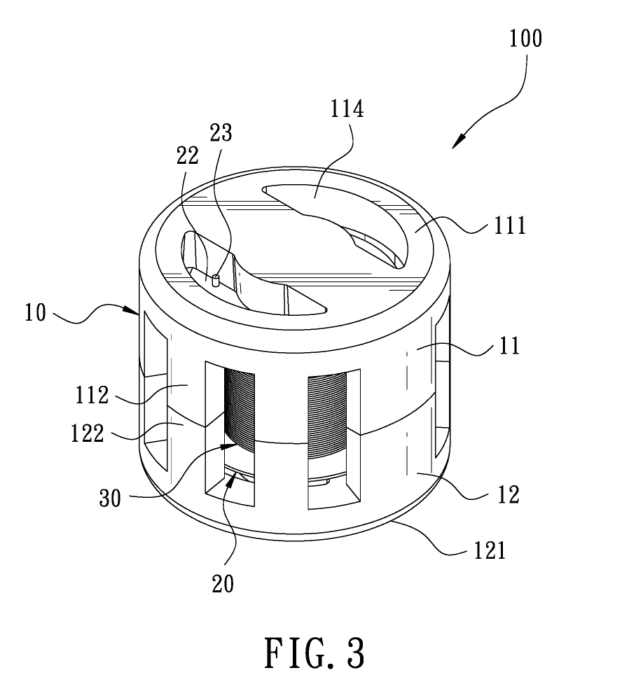

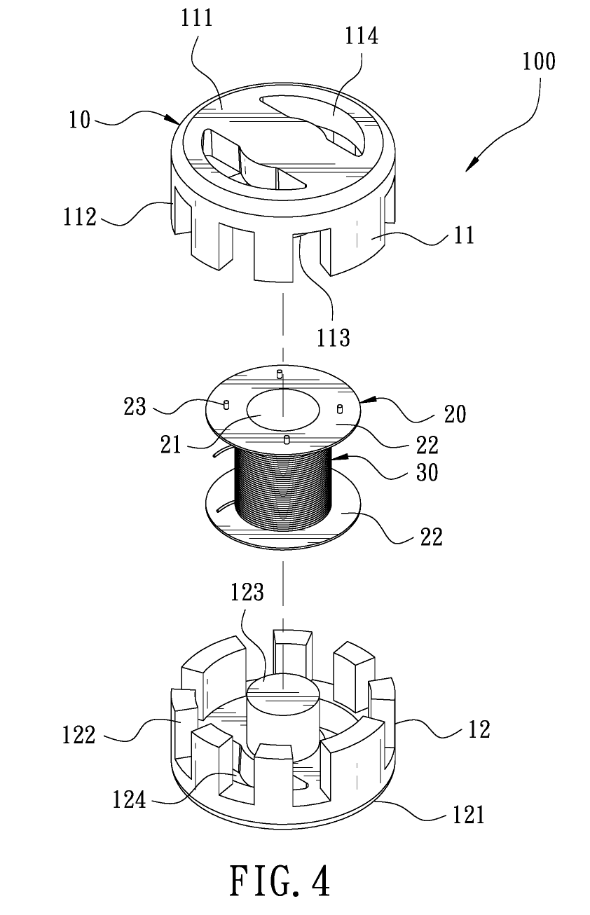

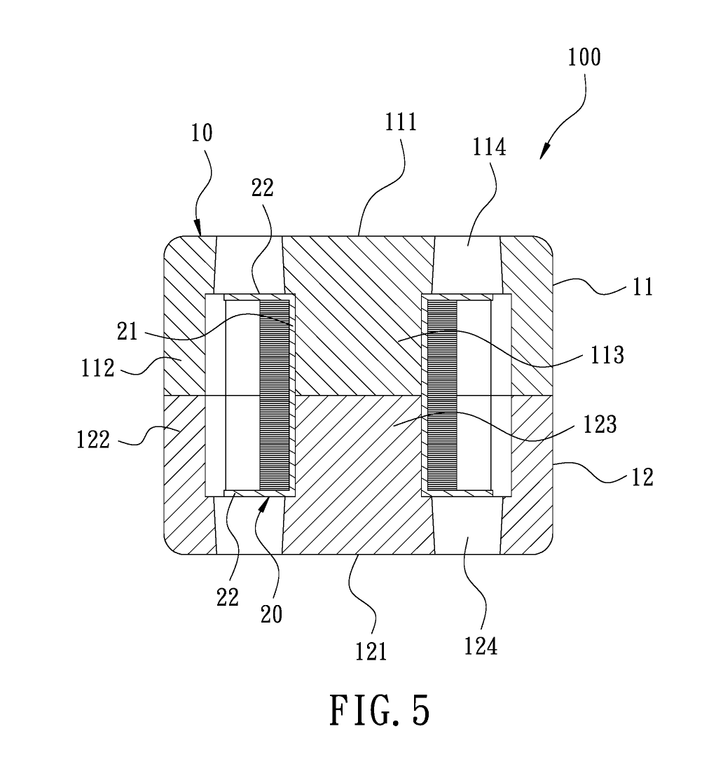

Referring to FIGS. 3, 4 and 5 which show a perspective view, an exploded view and sectional view of a power saving device used in a low voltage reactive power compensation assembly according to the present invention, a power saving device 100 comprises a iron core 10 which is made of Ni—Zn or Mn—Zn soft ferrite magnetic material by way of powder metallurgy to be sintered as an integral device. The iron core 10 comprises an upper iron core 11 and a lower iron core 12. The upper iron core has a top portion 111 substantially in a circular shape. Extended downwardly from the top portion 111 of the upper iron core 11, there are a plurality of vertical pillars 112 substantially separated in equal distance. In the center of the top portion 111 of the upper iron core 11, there extends an upper core 113 in the shape of a cylinder. The lower iron core 12 has a bottom portion 121. Extended upwardly from the bottom portion 121 of the lower iron core 12, there are a plurality of vertical pillars 122 substantially separated in equal distance and corresponding to the vertical pillars 112 of the upper iron core 11. In the center of the bottom portion 121 of the lower iron core 12, there extends a lower core 123 also in the shape of a cylinder and corresponding to the upper core 113 of the upper iron core 11. All the vertical pillars 112 and 122 are coaxially arranged with respect to the upper cores 113 and lower cores 123 of the upper iron core 11 and lower iron core 12. On the top portion 111 and lower portion 121, there are formed a pair of slots 114 and 124 substantially in the half moon shape.

A sleeve 20 comprises a hollow central bore 21 with flanges 22 extended outwardly from the end of the central bore 21. The central hollow bore 21 is fitted on the outer cylindrical surface of the upper core 113 and lower core 123. The flanges 22 will be against the upper portion 111 and the lower portion 121. The flanges 22 comprises a plurality of nodes 23 protruding into and against the inner wall of the slots 114 and 124. Therefore, the upper portion 111 will not be off set with respect to the lower portion 121.

A coil 30 is formed and installed on the outer cylindrical surface of the sleeve 20.

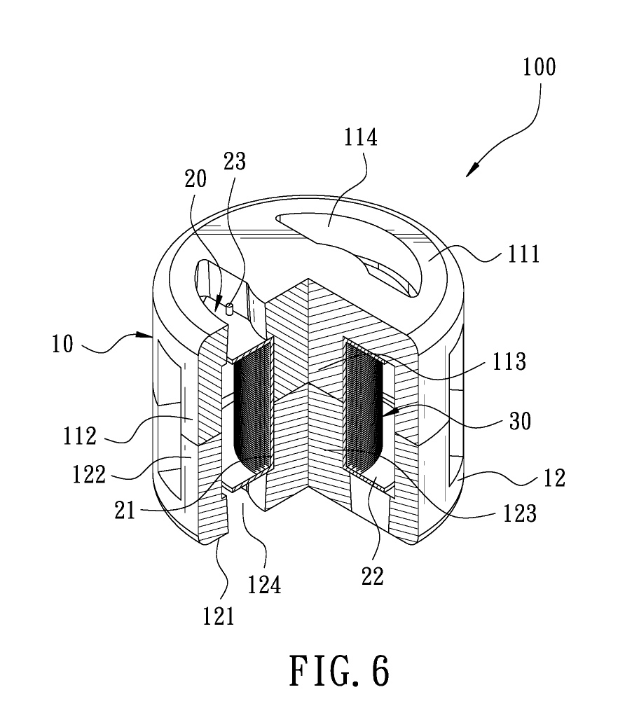

The procedure to assemble the power saving device 100 can be better understood with reference to FIG. 6 which is a partially sectional view of a power saving device 100 used in a low voltage reactive power compensation assembly according to the present invention. First, the coil 30 will be sleeved on the outer surface of the sleeve 20. The sleeve 20 will be pushed onto the lower iron core 123 and the flange 22 to be in touch with the lower portion 121. In the meantime, the nodes 23 will protrude and against the inner wall of the slot 124 to fix the position between the sleeve 20 and the lower portion 121. The upper iron core 113 is then sleeved into the central hollow core 21 of the sleeve 20 and in touch with the lower iron core 123. The flange 22 of the sleeve 20 will be in touch with the upper portion 111 and the nodes 23 will protrude and in touch with the inner surface of the slot 114. All the corresponding pillars 112 and 122 will be in touch and the upper iron core 11 and the lower iron core 12 to be assembled and formed as an integral power saving device 100.

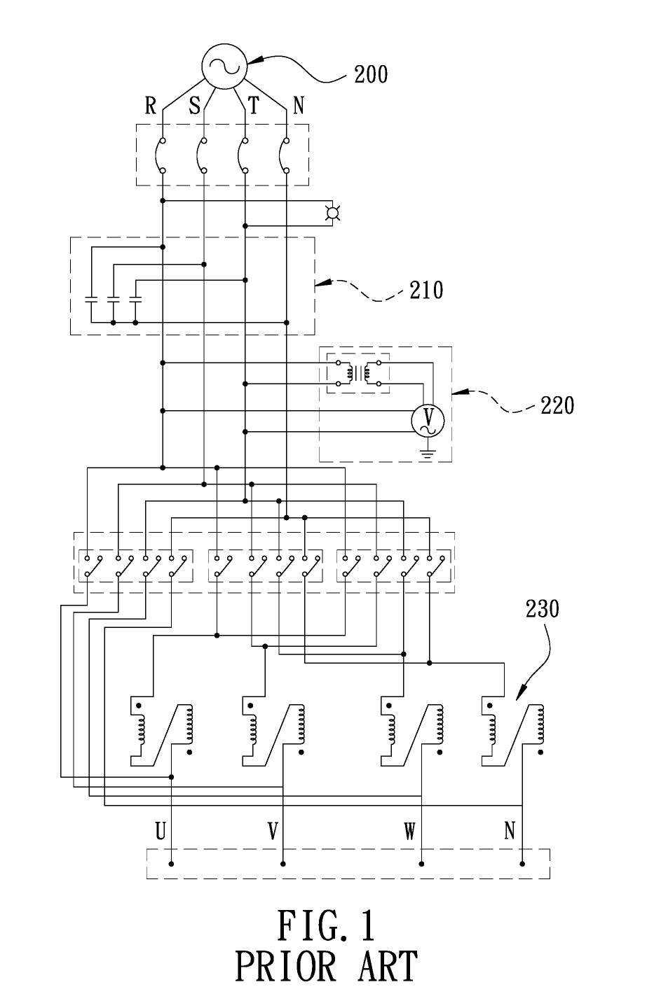

When the power saving device 100 according to the present invention shall be used in an assembly, which is similar to the one shown in FIG. 1, comprises a three-phase four lines alternative power supply 200, a power factor improving capacitor 210, a voltage measuring sequence controller 220 to measure the feedback load voltage from the various load and an inductive power saving device 230 along with each power line. Since the material of the power saving device 100 according to the present invention is Ni—Zn or Mn—Zn ferrite soft magnetic ones and sintered with power metallurgy, the magnet characteristic is good in high flux density and low eddy current and hysteresis loss. Also because the shape of the upper portion and lower portion of the iron core are in a circular shape, the flux shall be retained and saturated in the power saving device. Therefore, the entire power loss can be significantly decreased.

Although the low voltage reactive power compensation assembly with an improved power saving device of the present invention has been described in way of preferred embodiment, it is apparent and readily understood that various changes, improvement and modifications can still be made without departing from the spirit of the invention and shall be fallen in the protection scope as the Claims in the present invention.

What is claimed is:

1. A power saving device used in a low voltage reactive power compensation assembly comprising:
a magnetic iron core having an upper iron core and a lower iron core, each comprises a top portion with a plurality of first pillars extended therefrom and a lower portion with a plurality of second pillars extended therefrom and matching with said first pillars of the top portion, said upper iron core having a first magnetic core extended from said top portion, said lower iron core having a second magnetic core extend from said lower portion of said lower iron core; and
a coil assembled to sleeve onto said first and second magnetic cores.

2. A power saving device used in a low voltage reactive power compensation assembly according to claim 1 further comprising a sleeve having a central hollow bore to be sleeved on said first and second magnetic cores of said upper iron core and lower iron core, said sleeve comprising an upper flange and a lower flange to touch with said top portion of said upper iron core and said lower portion of said lower iron core.

3. A power saving device used in a low voltage reactive power compensation assembly according to claim 1, said upper portion of said upper iron core having a pair of first slots in a half moon shape, said lower portion of said lower iron core having a pair of second slots conforming with said first slot, said upper portion and lower portion further having a plurality of nodes formed thereon to be protruded into said first and second slots.

4. A power saving device used in a low voltage reactive power compensation assembly according to claim 1 wherein said magnetic iron core being made of Ni—Zn/Mn—Zn soft ferrite magnets.

5. A power saving device used in a low voltage reactive power compensation assembly according to claim 1 wherein said first magnetic core and said second magnetic core are in the shape of a cylinder.

6. A power saving device used in a low voltage reactive power compensation assembly according to claim 1 wherein said first pillars and said second pillars are coaxially with respect to said first and second magnetic cores.
